(19) United States
(12) Patent Application Publication
(10) Pub. No.: US 2023/0063367 A1
(43) Pub. Date: Mar. 2, 2023

(54) SYSTEM AND RELATED METHOD FOR DECREASING SYMPTOMS OF PRIMARY DYSMENORRHEA OF A PERSON

(71) Applicants: Hanna S. CHEN, Aurora, IL (US); Xi Chen, Aurora, IL (US)

(72) Inventors: Hanna S. CHEN, Aurora, IL (US); Xi Chen, Aurora, IL (US)

(21) Appl. No.: 17/459,638

(22) Filed: Aug. 27, 2021

(51) Int. Cl. A61H 39/06; A61H 39/00

(52) U.S. Cl. CPC A61H 39/06; A61H 39/002; A61H 2201/0207; A61H 2201/0264; A61H 2201/164; A61H 2201/5007; A61H 2205/102

(57) ABSTRACT

A system for decreasing symptoms of primary dysmenorrhea of a female person/patient. Such system includes an electrical assembly configured for attachment at an acupoint BL57 on each posterior calf skin of the patient proximately mid-length between the ankle and knee region of the patient. Each electrical assembly includes a heating element, a temperature sensor, a heat radiator for dissipating heat generated by the heating element, and an energy source. A pulse generating controller including a computer having logic circuitry powered by the energy source and carried by and arranged in electrical communication with the electrical assembly. The controller operates each heating element through a set or series of immediately consecutive heating and cooling cycles. Each heating and cooling cycle initially involves operating the heating element to warm the person's/patient's skin underlying the heating element as measured by the temperature sensor for a period of 10 to 30 seconds and to a temperature ranging between about 122° F. to about 126 F°. Immediately thereafter, the heat exchanger applies a cooling effect to the heating element whereby cooling the heating element as measured by the temperature sensor for a time period of 10 to 60 seconds. A method for decreasing symptoms of primary dysmenorrhea of a female person/patient is also disclosed.

### FIELD OF THE INVENTION DISCLOSURE

This invention disclosure relates to a system and method for decreasing symptoms and/or menstrual cramping discomfort of a female person/patient that is both convenient and easy to use.

### BACKGROUND

Primary dysmenorrhea is defined as discomfort and cramping pain in the lower abdomen occurring just or during menstruation, in the absence of other diseases. Prevalence rates are as high as 90 percent. The pain and/or discomfort is typically located in the pelvis or lower abdomen region of the person. Studies have shown, primary dysmenorrhea is a serious condition affecting millions of women in the United States alone. Primary dysmenorrhea is believed to be one of the largest contributors to absence of women from work, schools, and social engagements, among others. Medicines, such as those taken orally, to treat primary dysmenorrhea are known to have undesirable side effects in some women.

Alternatively, women have been known to rest and/or receive massage therapy in an effort to reduce the symptoms of primary dysmenorrhea. Applying heating pads to the stomach area also appears to reduce the symptoms of primary dysmenorrhea. These alternative treatments, however, tend to inhibit women from socializing and related activities.

Therefore, there is a need and continuing desire for a drug free system and method for decreasing the symptoms of primary dysmenorrhea and specifically menstrual pain, which readily allows freedom of movements, is effective and yet can be readily and easily controlled by the person seeking relief.

### SUMMARY

In view of the above, and in accordance with one aspect of this invention disclosure, there is provided a method of decreasing symptoms of primary dysmenorrhea of a female person/patient, using Applicant's knowledge, and understanding of electro-acupuncture techniques that are influenced by acupuncture theory of the meridians, energy channels distributed throughout a person's body. That is, one of the many salient features of this invention disclosure relates to positioning and attaching an electrical assembly on each posterior calf skin of the person/patient. According to this invention disclosure, the electrical assembly is positioned on each posterior calf skin of the patient proximately between the person's/ankle and knee. Each electrical assembly comprises an electrically operated heating element, a temperature sensor element adapted to be in contact with the posterior calf skin of the patient, a heat radiator configured to dissipate heat generated by the heating element, and an energy source.

Another step in the process involves providing a pulse generating controller including a computer and logic circuitry powered by the energy source and carried by and arranged in electrical communication with each electrical assembly. In one state, the controller is configured to operate the heating element of the multipiece assembly through a set or series of immediately consecutive and repetitive heating and cooling cycles. Each heating and cooling cycle initially involves raising and maintaining, for a period of 10 to 30 seconds, each heating element to a predetermined temperature ranging between about 122° F. to about 126° F. as measured by the temperature sensor. Immediately thereafter, the heat exchanger applies a cooling effect to the heating element. Applicants' research has surprisingly revealed applying repeated variable heat pulses to heat the acupoints on the back or rear of each calf of the person wearing the present invention disclosure brings warmth and comfort to the abdominal region and lower back region to help blood circulate and reduce menstrual pain for the person wearing the present invention disclosure.

The methodology of this invention disclosure can furthermore include a step of allowing for selective operation of the system for decreasing symptoms of primary dysmenorrhea of a female person/patient. This added step includes providing a manually operated switch for selectively controlling the power delivered by the power source to each electrical assembly and to each pulse generating controller depending upon the condition of the switch.

Another aspect of this invention disclosure relates to a system for decreasing symptoms of primary dysmenorrhea of a female person/patient. In developing this aspect of the invention disclosure, the Applicants again relied upon their knowledge and understanding of electro-acupuncture techniques that are influenced by acupuncture theory of the meridians, energy channels distributed throughout a person's body. According to this aspect of the invention disclosure, such system for decreasing symptoms of primary dysmenorrhea of a person patient includes an electrical assembly configured for attachment to each posterior calf skin of the person/patient. The electrical assembly is attached to each posterior calf skin of the patient proximately mid-length between the ankle and knee region of the patient. Each electrical assembly includes an electrically operated heating element, a temperature sensor adapted to be in contact with the posterior calf skin of the patient, a heat radiator configured to dissipate heat generated by the heating element, and an energy source.

Moreover, a pulse generating controller operably connected to a computer with logic circuitry is powered by the energy source and carried by and arranged in electrical communication with the electrical assembly. In one state, the controller is configured to operate the heating element of each electrical assembly through a set or series of immediately consecutive heating and cooling cycles. Each heating and cooling cycle initially involves operating the heating element for a period of 10 to 30 seconds at a predetermined temperature ranging between about 122° F. to about 126° F. as measured by the temperature sensor. Immediately thereafter, the heat exchanger applies a cooling effect to the heating element to reduce the operating temperature of the heating element for a time period of 10 to 60 seconds.

To allow for selective operation of the system for decreasing symptoms of primary dysmenorrhea of a female person/patient, each electrical assembly is preferably configured with a manually operated switch. In a preferred embodiment of this invention disclosure, the manually operated switch selectively controls power delivered by the power source to each electrical assembly and to each pulse generating controller depending upon the condition or state of the switch.

### DESCRIPTION OF THE DRAWINGS

FIG. 1 is a rear elevational view of a person/patient having one form of the present invention disclosure attached thereto;

FIG. 2 is an enlarged rear elevational view of a lower portion of the person's/patient leg having one form of the present invention attached thereto:

FIG. 3 is an enlarged and exploded perspective view of one form of an electrical assembly forming part if the present invention disclosure;

FIG. 4 is a perspective view of the electrical assembly forming part of the present invention disclosure;

FIG. 5 is an elevational view of the electrical assembly shown in FIG. 4;

FIG. 6 is an enlarged plan view of the electrical assembly shown in FIG. 4

FIG. 7 is a schematic illustration showing the repetitive and cyclic operation of the electrical assembly forming part of the present invention disclosure;

FIG. 8 is a fragmentary and schematic illustration of one cyclic operation of the electrical assembly forming part of the present invention disclosure; and

FIG. 9 is a schematic illustration of one form of logic circuitry used in operative combination with the electrical assembly forming part of the present invention disclosure.

### DETAILED DESCRIPTION

While this disclosure is susceptible of embodiment in multiple forms, there is shown in the drawings and will hereinafter be described a preferred embodiment of the disclosure, with the understanding the present disclosure sets forth an exemplification which is not intended to limit the invention disclosure to the specific embodiment illustrated and described.

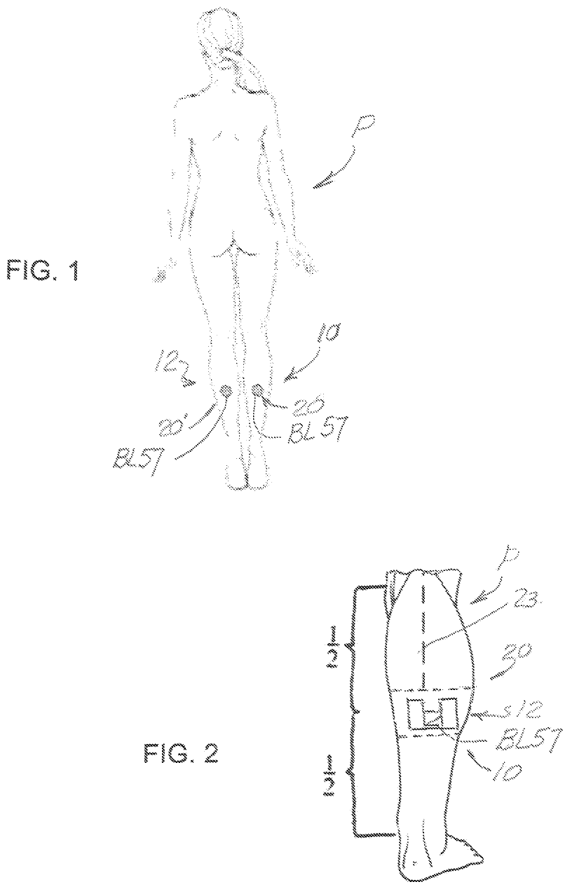

Referring now to the drawings, wherein like reference numerals indicate like parts throughout the several views, there is shown in FIG. 1 an elevational view of a female person/patient P having one form of a system for decreasing symptoms of primary dysmenorrhea suitably attached thereto. Unlike conventional thermal therapy, the system for decreasing symptoms of primary dysmenorrhea according to this invention disclosure, generally indicated in the drawing by reference numeral 10, uses variable heat pulses at acupoints on a person's/patient's P body. As will be appreciated, acupoints are like wells leading into the meridian under the person's/patient's skin. One of the salient features of the present invention relates to recognizing where to arrange, place and/or position system 10 relative to the person's/patient's P body to optimize the pain relief offered through use of the present invention disclosure.

According to the present invention disclosure, the system for decreasing symptoms of primary dysmenorrhea 10 comprises an electrical assembly 12 including at least two heat pulsating mechanisms 20 and 20′ which operate and function in concert relative to each other. To reduce manufacturing costs, the heat pulsating mechanisms 20 and 20′ are preferably substantially identical in construction and operation relative to each other. As such, only heat pulsating mechanism 20 will be discussed in detail.

Each heat pulsating mechanism is comprised of an assembly or collection of components and is configured for suitable attachment to the calf skin of the person/patient a predetermined distance between the ankle region and knee region of the patient. According to the present invention disclosure, and as schematically shown in FIG. 2, the acupoint to be heated by each heat pulsating mechanism (with only one being shown in FIG. 2) is at the back of the person's/patient's P calf located in the depression below the gastrocnemius formed when the leg muscle is flexed. That is, according to the present invention disclosure, the acupoint to be heated by each heat pulsating mechanism is on the posterior midline 23 of the person's/patient's P leg proximately midway between the person's/patient's knee and ankle when extending the toes straight and lifting the heel, better described as acupoint BL 57 based on World Health Organization standard.

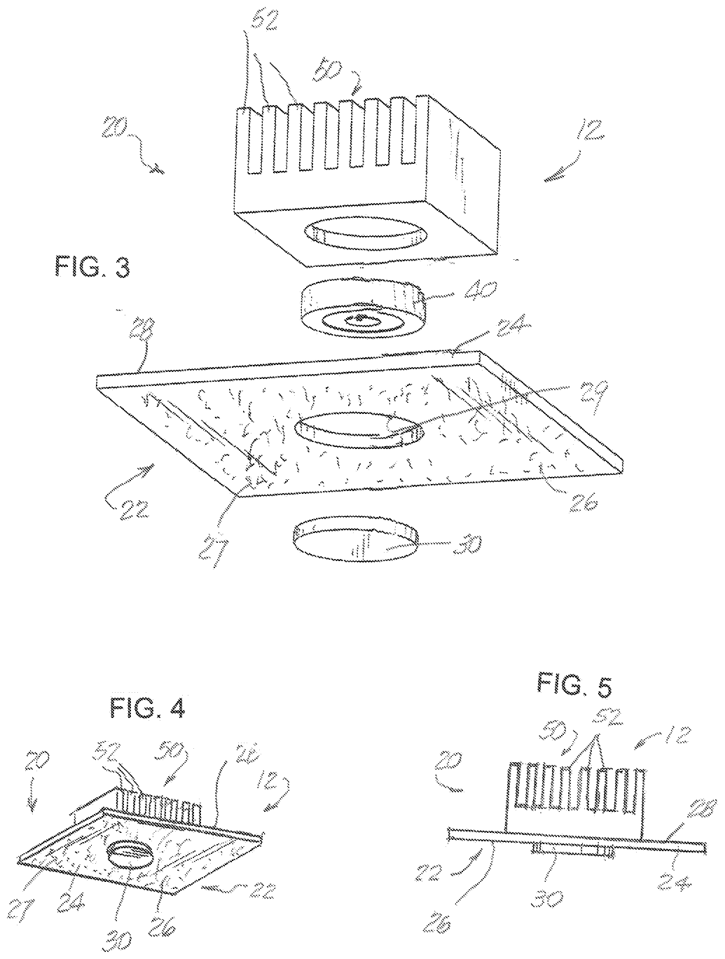

Turning to the schematic illustration in FIGS. 3, 4 and 5, one of the components comprising each heat pulsating mechanism is a holder 22 for suitably positioning and releasably securing each respective heat pulsating mechanism to the person's/patient's P leg. In one form, holder 22 includes a suitably configured sheet 24 of flexible fabric material having a generally planar inner layer 26 and outer layer 28. The inner layer 26 of sheet 24 has a suitable adhesive 26 for releasably holding/positioning the respective heat pulsating mechanism to back or rear of the person's/patient's calf. It should be appreciated, however, other types of devices, i.e., releasable straps and the like, could equally be used in conjunction with holder 22 to position/hold each heat pulsating mechanism to the calf of the person's/patient's leg without detracting or departing from the broad spirt and scope of this invention disclosure.

As illustrated in FIGS. 3, 4 and 5, another component forming part of each heat pulsating mechanism is an electrically powered temperature sensor element 30 arranged beneath and in operable combination with a heating element 40 to effectively measure the temperature of the person's/patient's skin underlying the sensor element 30 during operation of each heat pulsating mechanism. In one exemplary embodiment, the temperature sensor element 30 is a NTC type MS sensor sold by Amphenol Advanced Sensors located in St. Marys, Pa. and sold under Model No. RL0503-1248-73MS. As will be appreciated, the sensor 30 acts to produce and deliver an electrical signal representative or indicative of the temperature of the person's/patient's skin underlying the sensor 30 during operation of each heat pulsating mechanism. In a preferred embodiment, the sensor element 30 has a skin touching patch made of a suitable fabric material.

Another component forming part of each heat pulsating mechanism is the electrically powered heating element 40 (FIG. 3) arranged in axially stacked relation relative to the temperature sensor element 30. The heating element 40 is preferably configured as a rapid heating element sold by Analog Technologies of San Jose, Calif. and sold under Model No. AMCHC5R03W. Suffice it to say, the heating element 40 is operatively mounted in combination with and operably carried by the holder 22. As will be appreciated, the heating element 40 acts to produce and deliver an electrical signal representative or indicative of the temperature level applied to the person's/patient's underlying skin by the heating element 40 during operation of each heat pulsating mechanism.

Still another component forming part of each heat pulsating mechanism is a heat exchanger or heat radiator element 50 arranged in operable heat exchanging combination or relation relative to the respective heating element 40. In one form, the heat exchanger or heat radiator element 50 of each heat pulsating mechanism is configured with a series of upstanding cooling fins 52. During a cooling phase of operation of each heat pulsating mechanism, and while worn by the patient, the heat exchanger or heat radiator element 50 is configured to allow air to rapidly move across or past the fins 52 of the respective heat exchanger or heat radiator element 50 whereby yielding a fast and efficient methodology for quickly dissipating heat away from and while cooling the heating element 40 once power is no long directed thereto.

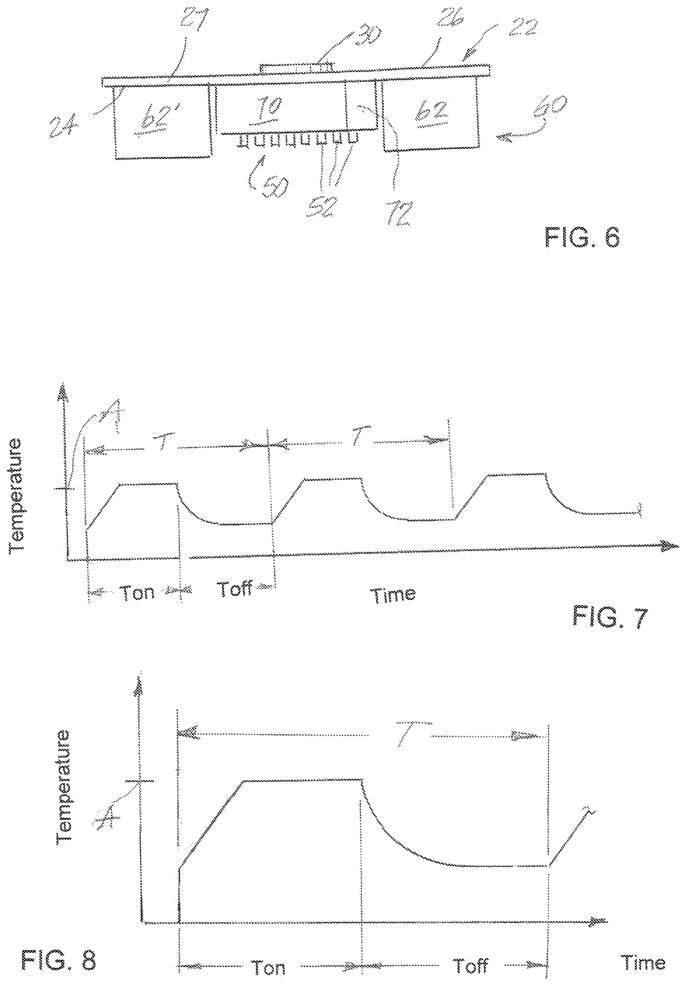

Turning now to FIG. 6, each heat pulsating mechanism further includes a power source, generally indicated by reference numeral 60. The power source 60 can be in the form of a conventional electrical line (not shown) allowing each heat pulsating mechanism to be directly connected to a conventional electrical outlet. Preferably, however, the power source 60 is in the form of suitable batteries 62, 62′ carried on and supported by holder 22 with a wireless connection (not shown) being provided between the batteries 62, 62′ and the electrically powered elements 30 and 40 (FIG. 3) of each heat pulsating mechanism.

As shown in FIG. 6, and unlike conventional heating pads and warm water bottles wherein heat is constantly applied to an area of a person's/patient's body, the electrical assembly 12 of the present invention further includes a controller 70 connected to and powered by the source 60. The controller 70 includes a programmable computer 72 that allows and controls the pulsating level of heat delivered and directed to the targeted acupoint BL57 (FIG. 1) on the rear calf of a person's/patient's body by the two heat pulsating mechanisms 20 and 20′ (FIG. 1) operating and functioning in concert relative to each other.

FIG. 7 provides a schematic illustration of the series of continuous non-interrupted heat cycles or pulses that are delivered to the targeted acupoint BLS7 (FIG. 1) on a person's/patient's body during operation of the two heat pulsating mechanisms 20 and 20′ (FIG. 1). Notably, the controller 70 is configured to receive and respond to signals from the temperature sensor element 30 and heating element 40 of each heat pulsating mechanism 20 and 20′ (FIG. 1). Each heat pulsating mechanism 20, 20′ (FIG. 1) can either be hard wired between the components thereof or, in an alternative embodiment, the components of each heat pulsating mechanism 20, 20′ (FIG. 1) can be interconnected as through a conventional star wireless connection or well-known Bluetooth connection.

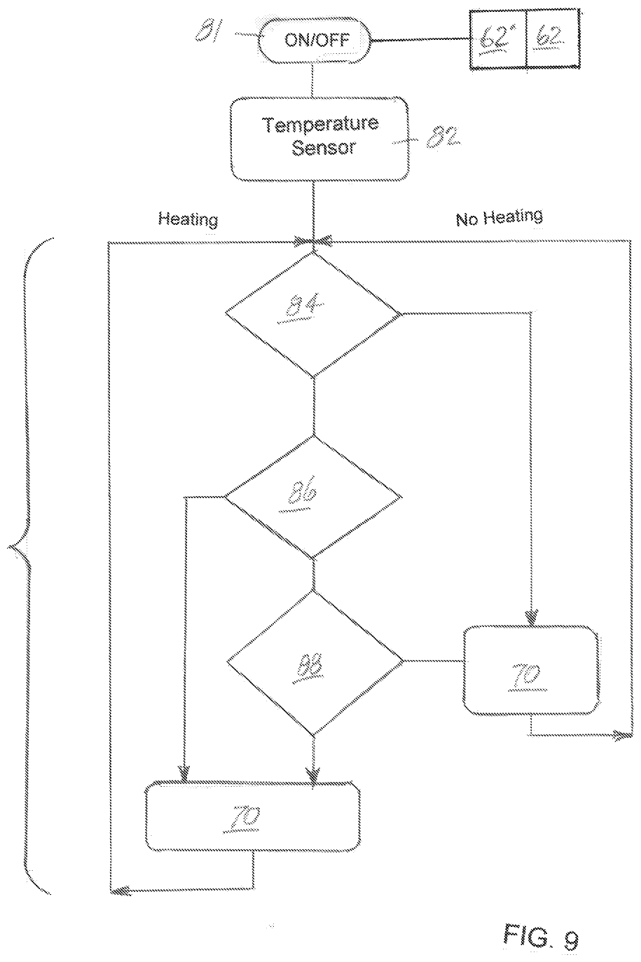

As illustrated in FIG. 7, and in preferred embodiment, the repeating and pulsating heating cycle for each heat pulsating mechanisms 20 and 20′ is substantially identical and, thus, only the cycle for mechanism 20 will be described in detail. As schematically illustrated in FIGS. 7 and 8, the duration of each heating cycle is indicated by the reference letter T and preferably is comprised of two-time segments Ton and Toff. It should be appreciated, however, the duration of the repeating and pulsating heating cycles can vary depending on the environmental temperature wherein the system 10 operates.

As indicated in FIG. 8, at the beginning of each heating cycle or when system 10 (FIG. 1) is initiated or started, and at the beginning of each consecutive cycle thereafter, the temperature of the respective pulsating mechanism begins at about the environmental temperature. Upon activation of the system 10, the temperature of the heating element 40 of each respective heat pulsating mechanism rises to a preset temperature indicated by Setpoint A of about 120° F. to about 130° F. as measured by the temperature sensing element 30 for a period extending between about 10 seconds to about 30 seconds. In a preferred embodiment, the temperature of the heating element 40 of each respective heat pulsating mechanism rises to a preset temperature indicated by Setpoint A of about 122° F. to about 126° F. as measured by the sensing element 30 for a period extending between about 10 seconds to about 30 seconds. The amount of time the heating element 40 is enabled or powered to apply heat to the chosen acupoint BL57 (FIG. 1) on the rear calf of the person wearing the present invention disclosure can vary depending upon the ambient or environmental temperature whereon the system 10 of the present invention is used.

As shown schematically in FIG. 7, after the heating element 40 of each heat pulsating mechanism serves to cyclically raise the temperature applied to the respective acupoint BL57 (FIG. 1) on a person's/patient's body to the preset temperature Setpoint A for the time period Ton, power to the heating element 40 is disabled whereby permitting the heat exchanger or heat radiator element 50, operably associated each heat pulsating mechanism, to quickly dissipate heat away from the respective heating element 40 until the time period of 10 to 60 seconds expires (Toff) is reached.

Turning to the schematic illustration in FIG. 9, the system of the present invention disclosure furthermore preferably includes a manually operated ON/OFF switch 81. In one form, switch 81 is of a conventional design and is configured to allow system 10 to operate in either of two states or conditions. In an OFF condition or state, switch 81 serves to economize on power. In an ON condition or state, switch 81 enables the batteries 62, 62′ to power or enable system 10 to operate. As schematically illustrated in FIG. 9, switch 81 is operably disposed between the power source or batteries 62, 62′ and the logic circuitry 74 used to operate system 10.

To allow the two heat pulsating mechanisms 20 and 20′ to operate and function in accordance with the above, the controller 70 is configured with logic circuitry 74. One example of the logic circuitry 74 used as part of the system 10 for decreasing symptoms of primary dysmenorrhea is schematically represented in FIG. 9. So as to allow the controller 70 to adjust and rapidly change various conditions experienced by system 10, the logic circuitry 74 is configured to cycle every one second during operation of system 10. It will be appreciated, the cycle time of the logic circuitry can be other than at one second intervals if so desired without departing or detracting from the novel spirit and scope of the present invention disclosure.

As schematically illustrated in FIG. 9, the logic circuitry 74 begins at Step 80 and upon each start of the system 10 (FIG. 1). At Step 82 of the logic circuitry 74 a signal is received from the temperature sensing element 30 representative or indicative of the temperature of the person's/patient's skin underlying the heating element 40 during operation of each heat pulsating mechanism.

At Step 84, the logic circuitry 74 receives a signal from the sensor element 30 and evaluates whether the temperature of the person's/patient's skin underlying the heating element 40 of each heat pulsating mechanism 20, 20′ is at the Setpoint A ranging between about 120° F. and about 130° F. In a most preferred form of the invention disclosure, Setpoint A ranges between about 122° F. and about 126° F. When the temperature sensor element 30 sends a signal at Step 84 of the logic circuitry 74 that the heating element 40 is operating such that the temperature of the person's/patient's skin underlying the heating element 40 ranges over Setpoint A, the logic circuitry 74 sends an electrical signal to disable the controller 70 from further heating the heat pulsating mechanisms 20, 20′ (FIG. 1). On the other hand, at Step 84 of the logic circuitry 74 and when the sensor element 30 sends a signal that the temperature of the person's/patient's skin underlying the heating element 40 as measured by the sensor element 30 of each heat pulsating mechanism 20, 20′ is less than that at Setpoint A, the logic circuitry 74 proceeds to send an electrical signal to Step 86 of the logic circuitry 74 indicative thereof.

At Step 86, the logic circuitry 74 of controller 70 examines how long or the time duration Ton (FIG. 8) each heat pulsating mechanism 20, 20′ has been operating At Step 86, and if the logic circuitry 74 of controller 70 calculates the heating element 40 of each heat pulsating mechanism 20, 20′ has been operational for a period of time less than about 10 to 30 seconds, Ton (FIGS. 7 and 8), the controller 70 is signaled to maintain the heating element 40 enabled whereby causing the heating element 40 to continue to rise in temperature. On the other hand, at Step 86, if the logic circuitry 74 of controller 70 calculates the heating element 40 of each heat pulsating mechanism 20, 20′ has been operational for a period of time ranging between about 10 to 30 seconds, the controller 70 is signaled accordingly and the program of the logic circuitry 74 moves or advances to Step 88 whereat the heating element 40 temporarily or cyclically disabled. With the heating element 40 disabled, the heat exchanger or heat radiator 50 serves to cool or operably reduce the operating temperature of the heating element 40 on the underlying calf skin of the person/patient.

At Step 88, the logic circuitry 74 of controller 70 examines the length or period of time Toff since the heating element 40 was disabled. At Step 88, the logic circuitry 74 regulates or controls the time duration Toff (FIG. 8) each heat pulsating mechanism 20, 20′ has been disabled. In one form, the time duration Toff (FIG. 8) each heat pulsating mechanism 20, 20′ is disabled ranges between about 10 seconds to about 60 seconds or a sufficient amount of time whereby allowing the heat radiator 50 to cool the heating element 40 to an operable temperature ranging between about 106 an 122 F. If, at Step 88, the computer 70 calculates the heating element 40 has been disabled for less than 10 seconds to 60 seconds, the logic circuitry will allow the radiator 50 to continue to operably cool the heating element 40. On the other hand, if at Step 88, the computer 70 calculates the heating element 40 has been disabled for greater than 60 seconds, the logic circuitry 74 of computer again initiates the heating element 40 and another cycle in the logic circuitry 74 begins again as schematically represented in FIGS. 8 and 9.

From the foregoing, it will be observed numerous modifications and variations can be made and effected without departing or detracting from the true spirit and novel concept of the invention disclosure. Moreover, it will be appreciated this invention disclosure merely sets forth an exemplification of the invention disclosure and is not intended to limit or otherwise restrict the invention disclosure to the specific embodiment illustrated. Rather, this invention disclosure is intended to cover by the appended claims all such modifications and variations as fall with the spirit and scope of the claims.

What is claimed is:

1. A method of decreasing a symptom of primary dysmenorrhea of a female person/patient, comprising the steps of:
positioning and attaching an electrical assembly as with a suitable holder on each posterior calf skin of said person/patient at an acupoint BL57 disposed halfway between a knee and ankle of said patient, wherein each electrical assembly comprises an electrically operated heating element, a temperature sensor element adapted to be in contact with the posterior calf skin of said patient, a heat radiator configured to dissipate heat generated by said heating element, and an energy source; and
providing a pulse generating controller including a computer and logic circuitry powered by said energy source and carried by and arranged in electrical communication with each electrical assembly, with said logic circuitry being configured to cycle said electrical assembly in one second intervals so as to operate said heating element of each electrical assembly through a series of consecutive cycles, with each cycle initially involving operating said heating element at a predetermined temperature ranging between about 122° F. to about 126° F. as measured every second by said temperature sensor for a time period of 10 to 30 seconds immediately followed by said heat exchanger applying a cooling effect to said heating element whereby cooling said heating element for a time period of 10 to 60 seconds.

2. The method of decreasing a symptom of primary dysmenorrhea of a female person/patient according to claim 1, comprising the further step of: providing a manually operated switch to selectively control power delivered by the power source to each electrical assembly and to each pulse generating controller depending upon the condition of said switch.

3. A system for decreasing a symptom of primary dysmenorrhea of a patient, said system comprising:
an electrical apparatus including two electrical assemblies, with each electrical assembly being configured for attachment to the posterior calf skin of said patient at an acupoint BL57 disposed halfway between an ankle and knee of said patient, wherein each electrical assembly comprises an electrically operated heating element, a temperature sensor adapted to be in contact with the posterior calf sin of said patient, a heat radiator configured to dissipate heat generated by said heating element, and an energy source; and
a pulse generating controller including a computer with logic circuitry powered by said energy source and carried by and arranged in electrical communication with each electrical assembly, with said controller being selectively operated by said logic circuitry such that each electrical assembly is consecutively cycled in one second intervals, with each cycle of said heating element of each electrical assembly involving operating said heating element at a predetermined temperature ranging between 122° F. to about 126° F. as measured every second by said temperature sensor for a time period of 10 to 30 seconds immediately followed by said heat exchanger applying a cooling effect to said heating element as measured by said temperature sensor for a time period of 10 to 60 seconds.

4. The system for decreasing a symptom of primary dysmenorrhea of a patient according to claim 3, wherein the said electrical apparatus further includes a manually operated switch for selectively controlling power delivered by the power source to each electrical assembly and to each pulse generating controller depending upon the condition of said switch.
